(19) United States
(12) Patent Application Publication
(10) Pub. No.: US 2025/0012927 A1
(43) Pub. Date: Jan. 9, 2025

(54) OPTICAL INTERFEROMETER, LASER CONTROL DEVICE, TRANSMITTING DEVICE FOR A LIDAR SYS-TEM, LIDAR SYSTEM, VEHICLE HAVING AT LEAST ONE LIDAR SYSTEM, AND METHOD FOR OPERATING AN OPTICAL INTERFEROMETER

(71) Applicant: VALEO SCHALTER UND SENSOREN GMBH, Bietigheim-Bissingen (DE)

(72) Inventors: Christoph Parl, Bietigheim-Bissingen (DE); Bernd Bertschinger, Bietigheim-Bissingen (DE); Thomas Schuler, Bietigheim-Bissingen (DE); Thorsten Beuth, Bietigheim-Bissingen (DE)

(73) Assignee: VALEO SCHALTER UND SENSOREN GMBH, Bietigheim-Bissingen (DE)

(21) Appl. No.: 18/711,107

(22) PCT Filed: Nov. 23, 2022
(86) PCT No.: PCT/EP2022/082969

§ 371 Date: May 17, 2024

(30) Foreign Application Priority Data
Nov. 29, 2021 (DE) 10 2021 131 253.1

(51) Int. Cl. G01S 17/931; G01S 7/484; G02F 1/21

(52) U.S. Cl. CPC G01S 17/931; G01S 7/484; G02F 1/212; G02F 2203/15

(57) ABSTRACT

An optical interferometer is disclosed. The optical interferometer includes at least two optical branches for guiding optical waves. At least one of the at least two optical branches includes at least one optical microresonator arranged in the optical branch to delay optical waves in the corresponding at least optical branch.

### TECHNICAL FIELD

The invention relates to an optical interferometer, in particular for a LiDAR system, in particular for a laser control device for at least one laser of at least one LiDAR system, in particular for a vehicle, having at least two optical branches for guiding optical waves.

The invention further relates to a laser control device for at least one laser, in particular for at least one laser for at least one LiDAR system, in particular for at least one vehicle, having at least one optical interferometer for interferometrically treating laser waves generated by the at least one laser, having at least one evaluation means for determining control variables from laser waves interferometrically treated by the at least one interferometer and having at least one control means for controlling the at least one laser on the basis of control variables determined by at least one evaluation means.

Additionally, the invention relates to a transmitting device for a LiDAR system, in particular for a vehicle, having at least one laser for generating laser waves and having at least one laser control device for controlling the at least one laser.

Furthermore, the invention relates to a LiDAR system, in particular for at least one vehicle, having at least one transmitting device for transmitting optical waves into at least one monitoring area, having at least one receiving device for receiving optical waves from the at least one monitoring area and having at least one control and evaluation device for controlling the at least one transmitting device and the at least one receiving device and for evaluating received variables determined by the receiving device.

In addition, the invention relates to a vehicle having at least one LiDAR system.

Moreover, the invention relates to a method for operating an optical interferometer, in particular for a LiDAR system, in particular for a laser control device for at least one laser of at least one LiDAR system, in particular for a vehicle, in which optical waves are split into at least two optical branches, and the optical waves are each guided in the optical branches, the optical waves being delayed in at least one of the at least two branches.

### PRIOR ART

A LIDAR system is known from US 2020/0018857 A1. The LIDAR system comprises a communication connection comprising or consisting of one or more optical fibers that transmit data between a LIDAR chip and remote electronics. The LIDAR chip contains a laser resonator. The laser resonator contains a light source that may contain or consists of a gain medium for a laser. The chip contains a control branch to control the operation of the laser resonator. The control branch contains a directional coupler that redirects part of the outgoing LIDAR signal from a supply waveguide to a control waveguide. The control waveguide guides the tapped signal to an interferometer that splits the tapped signal and then recombines the various parts of the tapped signal with a phase difference between the parts of the tapped signal.

The invention is based on the object of creating an optical interferometer, a laser control device, a transmitting device, a LiDAR system, a vehicle and a method of the type mentioned at the outset in which the optical interferometer can be implemented in a better, in particular more compact and/or more robust and/or more powerful, manner.

### DISCLOSURE OF THE INVENTION

The invention achieves the object for the interferometer in that at least one of the at least two optical branches has at least one optical microresonator arranged in it to delay optical waves in the corresponding at least one optical branch.

According to the invention, an optical delay element in the form of an optical microresonator is used to delay the optical waves for the optical interferometer. The delay can be used to specify an operating point of the interferometer.

Optical microresonators can be used to hold optical waves for several microseconds, and thereby to produce corresponding delays. The optical properties such as coherence, phase and polarization of the optical waves are preserved in the optical microresonator.

Optical microresonators can be implemented in a much more compact manner than optical delay elements in the form of external fiber optic cables.

When used in conjunction with LiDAR systems for vehicles, the optical microresonators can occupy surface areas in the region of a few square micrometers. In order to achieve comparable delays, fiber optic cables require several square millimeters. Optical microresonators can be used to implement the interferometer according to the invention in a much more compact manner. Such compact interferometers are particularly suitable for connection to integrated optics, so-called photonic integrated circuits (PIC).

The use of optical microresonators instead of fiber optic cables as delay elements can also reduce the cost of the interferometer.

Furthermore, optical microresonators having greater mechanical sturdiness than fiber optic cables can be implemented. In addition, optical microresonators can be operated with lower coupling losses than fiber optic cables. Finally, optical microresonators, unlike fiber optic cables, may be designed so that they can be adjusted even after assembly, in particular even during operation.

“Optical” within the context of the invention refers to visible and invisible ranges of electromagnetic waves, in particular light waves. The components labeled “optical” are accordingly suitable for use in connection with visible and invisible ranges of electromagnetic waves. The optical waves interferometrically treated by the optical interferometer may be light waves, in particular laser waves, in the visible or invisible range.

The optical interferometer can be used to generate interference signals by superimposing optical waves guided by the at least two optical branches. The interference signals can be used to characterize properties of optical waves that are supplied to the optical interferometer, in particular wavelength, phase and/or polarization. As such, the interference signals can be used when using the interferometer in conjunction with a laser control device to control the laser.

Advantageously, the interferometer can have at least one input coupler, in particular a beam splitter or the like, at the beginning of the at least two optical branches. The at least one input coupler can be used to inject optical waves into the at least two optical branches. The optical waves can be split over the at least two optical branches by the at least one input coupler.

Advantageously, the interferometer can have at least one output coupler, in particular a beam splitter, at the end of the at least two optical branches. The at least one output coupler can be used to merge optical waves from the at least two optical branches. The optical waves from the at least two optical branches can be superimposed by the at least one output coupler. The superimposed optical waves can be used to form an interference signal.

Advantageously, the interferometer can be used in conjunction with a light detection and ranging system (LiDAR). In this way, optical waves used with the LiDAR system to monitor a monitoring area can be interferometrically treated by the interferometer. As such, optical waves, in particular interference signals, interferometrically treated by the interferometer can be used to control functions of the LiDAR system.

Advantageously, the interferometer can be used in conjunction with a frequency modulated continuous wave LiDAR system, referred to as an FMCW LiDAR system. Using the interferometer, in particular using interference signals determined by the interferometer, the output wavelength of a source for the optical waves, in particular a laser, of the FMCW LiDAR system can be controlled more accurately.

Advantageously, the optical interferometer can be used in a laser control device for at least one laser of at least one LiDAR system. In this way, laser waves generated by the at least one laser and interferometrically treated by the interferometer can be used to determine control variables for controlling the laser. As such, the laser control device can be used to control, in particular regulate, the at least one laser on the basis of the laser waves interferometrically treated by the optical interferometer.

When using the interferometer in a laser control device for at least one laser of a LiDAR system, the delay line attained with the delay element should be a fraction of the maximum range of the LiDAR system, in particular half of the maximum range of the LiDAR system. The optical delay element according to the invention in the form of an optical microresonator can be used to attain delays in the optical waves that are required for a LiDAR system having a range of several hundred meters. In order to attain this delay using delay elements in the form of fiber optic cables, a much greater outlay, in particular a greater space requirement and higher costs, would be required.

Advantageously, the at least one laser may be a diode laser. Diode lasers can be implemented in a particularly compact manner. Advantageously, the at least one laser may have or consist of at least one surface emitter. In this way, the at least one laser can be implemented in an even more compact manner. A surface emitter, also referred to as a vertical cavity surface emitting laser (VCSEL), is a semiconductor laser in which the light is emitted perpendicular to the plane of the semiconductor chip.

The invention can advantageously be used in vehicles, in particular motor vehicles. Advantageously, the invention can be used in land vehicles, in particular passenger vehicles, trucks, buses, motorcycles or the like, aircraft, in particular drones, and/or watercraft. The invention can also be used in vehicles that can be operated autonomously or at least semi-autonomously. However, the invention is not restricted to vehicles. It can also be used in stationary operation, in robotics and/or in machines, in particular construction or transport machinery, such as cranes, excavators or the like.

Advantageously, the optical interferometer can be used for a LiDAR system of a vehicle. The LiDAR system can be used to monitor the surroundings and/or interior of the vehicle.

The LiDAR system can advantageously be connected to at least one electronic control apparatus of a vehicle or a machine, in particular a driver assistance system or the like, or be part of such a control apparatus. In this way, at least some of the functions of the vehicle or of the machine can be performed autonomously or semi-autonomously.

The LiDAR system can be used to detect stationary or moving objects, in particular vehicles, people, animals, plants, obstacles, uneven driving surfaces, in particular potholes or stones, roadway boundaries, road signs, free spaces, in particular parking spaces, precipitation or the like, and/or movements and/or gestures.

In one advantageous embodiment, at least one optical microresonator may be a traveling wave resonator, an optical whispering gallery resonator and/or a ring resonator, in particular an integrated ring resonator, and/or the optical interferometer may be implemented as part of an integrated optical system. In this way, the interferometer can be implemented in an even more compact manner.

A traveling wave resonator can be used to generate standing waves.

Optical waves can be trapped in a whispering gallery resonator for a defined time.

In the case of a ring resonator, the waves can be guided along the perimeter of the ring on a circulating propagation path, the total reflection by the peripheral face of the ring resonator and the constructive interference in the circulating optical wave leading to whispering gallery modes. Integrated ring resonators can be implemented in a more compact manner. This allows the space requirement of the interferometer to be reduced further overall.

Advantageously, the optical microresonator may be an optical whispering gallery resonator in the form of an integrated traveling wave ring resonator. In this way, the delay element in the form of the optical microresonator may be of particularly compact and powerful design.

In addition or alternatively, the optical interferometer may advantageously be implemented as part of an integrated optical system. In this way, the optical interferometer and any other components, in particular of a LiDAR system, can be built in a more compact manner overall.

For integrated optical systems, the term “integrated optics” or “photonic integrated circuit” (PIC) can also be used.

In another advantageous embodiment, at least one of the optical branches may have at least two optical microresonators arranged functionally in parallel in it and/or at least one of the optical branches may have at least two optical microresonators arranged functionally in series in it. In this way, the delay for optical waves can be set even more accurately. A series arrangement of multiple optical delay elements permits the delay times to be extended.

In another advantageous embodiment, at least one optical microresonator may have at least one associated adjusting means. The at least one adjusting means can be used to set the delay for optical waves that is achieved by the at least one optical microresonator.

Advantageously, at least one adjusting means may be suitable for changing a characteristic impedance of the optical microresonator. Changes in the characteristic impedance can be used to specify the times at which optical waves are injected into the optical microresonator and decoupled from the optical microresonator. This also allows confinement times of optical waves in the optical microresonator and thus delay times to be defined.

Advantageously, at least one adjusting means may have at least one temperature changing means. In this way, the temperature of the at least one optical microresonator can be set. Temperature changes can cause changes in the characteristic impedance. Temperature changes can thus be used to set times for the injection and decoupling of the optical wave and thus delay times.

The invention also achieves the object for the laser control device in that the laser control device has at least one interferometer according to the invention.

According to the invention, the laser control device has an interferometer in which at least one optical microresonator is arranged in at least one of the optical branches as a delay element.

In this way, the laser control device can be implemented in a very compact manner. In addition, the at least one interferometer can be precisely adjusted by the at least one optical microresonator. The at least one optical microresonator may also be designed so that it and thus the operating point of the at least one interferometer can still be adapted even after installation. This allows control of the at least one laser to be improved further.

In one advantageous embodiment, at least one output of at least one interferometer may have at least one electro-optical detector arranged downstream of it, which may be connected to at least one evaluation means of the laser control device for signal transfer purposes. The at least one electro-optical detector can be used to convert optical waves interferometrically treated by the interferometer, in particular optical interference signals, at the output of the at least one interferometer into electrical signals. The electrical signals can be transferred to the at least one evaluation means. The electrical signals can be processed by the at least one evaluation means, in particular to produce control variables.

Advantageously, the at least one evaluation means may be an electronic evaluation means. The at least one electronic evaluation means can be used to determine electrical control variables from electrical signals that come from the at least one electro-optical detector. The electrical control variables can be used to control the at least one laser. In particular, the output wavelength of laser waves generated by the at least one laser can thus be set and regulated.

Advantageously, the at least one electro-optical detector may be designed as a point detector, in particular as a photodiode or the like, a line detector, in particular as a diode array or the like, or an area detector, in particular as a CCD array or an active pixel array or the like. In this way, the selection for the at least one electro-optical detector can be matched to the design and/or the intended use of the interferometer.

In another advantageous embodiment, at least one evaluation means of the laser control device and/or at least one control means of the laser control device may be implemented at least in part by means of a control and evaluation device of at least one LiDAR system. In this way, the at least one evaluation means and/or the at least one control means and at least one control and evaluation device may be implemented in a more compact manner. In addition, components, in particular processors and/or software routines or the like, that are already present in the control and evaluation device of the at least one LiDAR system can be used to implement the at least one evaluation means and/or the at least one control means.

Advantageously, at least one evaluation means of the laser control device and/or at least one control means of the laser control device may be integrated at least in part in a control and evaluation device of at least one LiDAR system. In this way, the LiDAR system can be designed in an even more compact manner overall.

Advantageously, the at least one evaluation means, the at least one control means and/or the at least one control and evaluation device may be implemented by way of software and/or hardware. In this way, the at least one LiDAR system can be implemented in a more compact and more powerful manner overall.

Additionally, the invention achieves the object for the transmitting device in that the transmitting device has at least one laser control device according to the invention.

According to the invention, the transmitting device has at least one laser control device according to the invention for controlling at least one laser with at least one interferometer according to the invention. The at least one interferometer according to the invention has at least one optical microresonator as a delay element. The interferometer according to the invention can be used to determine precise information about the laser waves generated by the at least one laser. This information can be taken as a basis for controlling the at least one laser more accurately.

Overall, the transmitting device can be built in a more compact manner by using at least one optical microresonator as a delay element. In addition, the transmitting device can be implemented in a mechanically more sturdy manner than when used with fiber optic cables as delay elements.

In addition, optical microresonators, unlike fiber optic cables, may also be designed so that they can be adjusted during the operation of the transmitting device. Thus, the setting of the at least one laser, in particular the output wavelength of the generated laser waves, can be altered even during operation. In particular, the output wavelength can be regulated by the at least one laser control device. Divergences of the output wavelength from a target output wavelength can be detected using the interferometer according to the invention. The presence of divergences can result in the at least one laser being regulated accordingly by the at least one laser control device. Thus, operating and/or environmental influences, in particular temperature influences, on the at least one laser, in particular on the properties of the laser waves generated by the at least one laser, can be compensated for.

In one advantageous embodiment, at least one laser and at least one interferometer of the at least one laser control device may have at least one optical branching means, in particular at least one beam splitter, arranged between them to split the laser waves generated by the at least one laser. The at least one optical branching means can be used to split laser waves. Some of the laser waves can be routed to the interferometer. This portion of the laser waves can be interferometrically treated by the at least one interferometer. In this way, the at least one laser can be regulated by the at least one laser control device on the basis of the laser waves generated by the at least one laser.

In another advantageous embodiment, the transmitting device may be implemented at least in part as integrated optics. In this way, the transmitting device can be built in a more compact manner.

Parts of the transmitting device that are implemented as integrated optics can be combined with other parts, in particular of at least one receiving device, of the LiDAR system that are implemented as integrated optics. In this way, the LiDAR system can be built in an even more compact manner.

In addition, the invention achieves the object for the LiDAR system in that the LiDAR system has at least one transmitting device according to the invention.

According to the invention, the LiDAR system has at least one transmitting device having at least one laser control device that comprises at least one interferometer according to the invention. The at least one interferometer according to the invention has at least one optical microresonator as an optical delay element. The use of optical microresonators allows the LiDAR system to be implemented in a more compact and more robust manner overall. Furthermore, the LiDAR system, in particular at least one laser of the LiDAR system, can be controlled more accurately.

In one advantageous embodiment, the at least one LiDAR system may be implemented at least in part as integrated optics. In this way, the LiDAR system can be built in an even more compact manner.

Furthermore, the invention achieves the object for the vehicle in that the vehicle has at least one LiDAR system according to the invention.

According to the invention, at least one LiDAR system of the vehicle has at least one transmitting device having at least one laser control device having an interferometer according to the invention. The at least one interferometer according to the invention has at least one optical microresonator as an optical delay element. The use of optical microresonators allows the LiDAR system to be implemented in a more compact and more robust manner overall. Furthermore, the LiDAR system, in particular the at least one laser of the LiDAR system, can be controlled more accurately.

Advantageously, the vehicle can have at least one driver assistance system. A driver assistance system can be used to operate the vehicle autonomously or semi-autonomously.

Advantageously, at least one LiDAR system of the vehicle may be functionally connected to at least one driver assistance system. In this way, information about at least one monitoring area, in particular distances, directions and/or speeds of detected objects determined by the at least one LiDAR system, can be used with the at least one driver assistance system to control autonomous or semi-autonomous operation of the vehicle.

Moreover, the invention achieves the object for the method in that the optical waves in at least one optical branch are reflected to delay them.

According to the invention, the optical waves are reflected for a certain time in the at least one optical branch, in particular in at least one optical microresonator, to delay them. The reflection increases a distance for the optical waves in the at least one microresonator, which leads to a corresponding increase in the dwell time of the optical waves in the at least one optical microresonator and thus to a delay. The reflection allows the space requirement of the at least one optical resonator for delaying the optical waves to be reduced, in contrast to the use of delay lines in the form of fiber optic cables. This allows the optical interferometer to be built in a more compact manner overall. Given identical dimensions, the method according to the invention can be used to implement greater increase distances than when external fiber optic cables are used as delay elements.

Advantageously, an optical traveling wave and/or an optical whispering gallery mode can be generated in at least one of the optical branches for the optical wave. In this way, the optical wave can be selectively delayed while maintaining the optical properties such as coherence, phase and polarization.

Advantageously, the optical wave can be totally reflected by interfaces of an annular optical microresonator and optical whispering gallery modes can be generated from the interference of circulating optical waves.

In one advantageous configuration of the method, the delay time for the optical wave in the at least one optical branch can be set. The delay time can be used to set an operating point of the interferometer.

Advantageously, an optical wave at the output of the interferometer can be used to control a laser. In this way, the interferometer can be used to adjust the laser wave generated by the laser, in particular to control, in particular regulate, the output wavelength.

Moreover, the features and advantages indicated in connection with the interferometer according to the invention, the laser control device according to the invention, the transmitting device according to the invention, the LiDAR system according to the invention, the vehicle according to the invention and the method according to the invention and the respective advantageous configurations thereof apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider individually the features that have been disclosed in combination in the drawing, the description and the claims and will combine them to form meaningful further combinations. In the drawing, schematically,

FIG. 1 shows a front view of a vehicle having a driver assistance system and a LiDAR system for monitoring a monitoring area in front of the vehicle in the direction of travel;

FIG. 2 shows a functional representation of the LiDAR system according to a first exemplary embodiment and of the driver assistance system of the vehicle from FIG. 1;

FIG. 3 shows a representation of a confinement of laser signals in an optical microresonator of an interferometer of a laser control device of the LiDAR system from FIG. 2 as a ray optical model;

FIG. 4 shows a representation of the confinement of laser signals in the optical microresonator from FIG. 3 as a wave optical model;

FIG. 5 shows a functional representation of a LiDAR system according to a second exemplary embodiment and of the driver assistance system of the vehicle from FIG. 1;

FIG. 6 shows an interferometer of a LiDAR system according to a third exemplary embodiment;

FIG. 7 shows an interferometer of a LiDAR system according to a fourth exemplary embodiment.

In the figures, identical components are provided with identical reference signs.

### EMBODIMENT(S) OF THE INVENTION

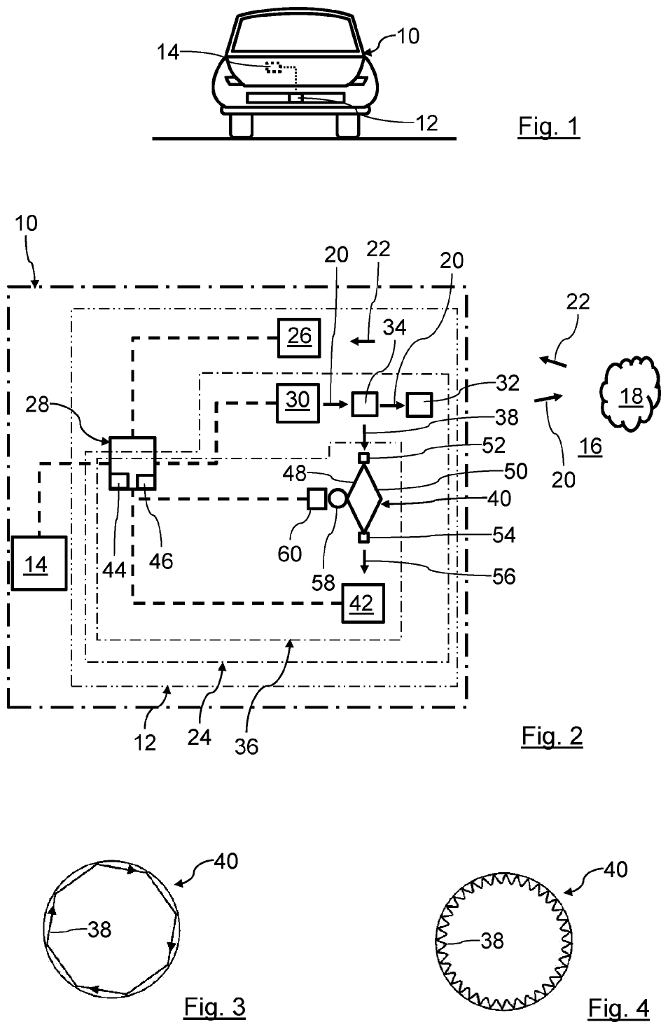

FIG. 1 shows the front view of a vehicle 10 in the form of a passenger vehicle. The vehicle 10 comprises a LiDAR system 12 and a driver assistance system 14. FIG. 2 shows a functional diagram of the LiDAR system 12 according to a first exemplary embodiment and of the driver assistance system 14 in the vehicle 10.

The LiDAR system 12 is arranged in the front bumper of the vehicle 10 by way of illustration. The LiDAR system 12 is directed into a monitoring area 16 in front of the vehicle 10 in the direction of travel. The LiDAR system 12 can be used to monitor the monitoring area 16 for objects 18, for example. The LiDAR system 12 may also be arranged with a different alignment in a different position on the vehicle 10. The vehicle 10 may also have multiple identical, similar or different LiDAR systems 12.

The LiDAR system 12 can be used to detect stationary or moving objects 18, for example vehicles, people, animals, plants, obstacles, uneven driving surfaces, for example potholes or stones, roadway boundaries, road signs, free spaces, in particular parking spaces, precipitation or the like, and/or movements of objects 18 and/or gestures.

The LiDAR system 12 can be used to determine information about objects 18, for example distances, directions and/or speeds of detected objects 18 relative to the LiDAR system 12 and thus relative to the vehicle 10.

The LiDAR system 12 is functionally connected to the driver assistance system 14. The connection can be used to transfer information from the monitoring area 16 that can be obtained by the LiDAR system 12 to the driver assistance system 14.

The driver assistance system 14 can be used to autonomously or semi-autonomously control functions of the vehicle 10, for example driving functions, for example inter alia on the basis of the information obtained by the LiDAR system 12.

The LiDAR system 12 is designed as a so-called FMCW LiDAR system by way of illustration. The LiDAR system 12 can be used to transmit optical transmission signals 20 in the form of optical waves, namely laser waves, into the monitoring area 16. The transmission signals 20 are frequency-modulated continuous wave (FMCW) signals.

The electromagnetic transmission signals 20 can be reflected by objects 18 located in the monitoring area 16 and can be received as echo signals 22, also in the form of laser waves, by the LiDAR system 12.

The transmission signals 20 and the echo signals 22 can be taken as a basis for using the LiDAR system 12 to determine distances, directions and speeds of detected objects 18 relative to the LiDAR system 12. Distances can be determined from propagation times of the transmission signals 20 and the echo signals 22 from transmission of the transmission signals 20 to reception of the echo signals 22.

The LiDAR system 12 comprises, as shown in FIG. 2, a transmitting device 24, a receiving device 26 and a control and evaluation device 28.

The transmitting device 24 comprises a laser 30, transmission optics 32, a branching means 34 and a laser control device 36.

The laser 30 can be used to generate the transmission signals 20 in the form of laser waves.

The branching means 34 can be implemented as a beam splitter, for example. The branching means 34 can be used to split the transmission signals 20 generated by the laser 30 into two portions. One portion can be branched off as a control signal 38. The control signal 38 can be transmitted to an optical interferometer 40 of the laser control device 36.

The portion of the transmission signals 20 that is not branched off can be widened by the transmission optics 32 and transmitted into the monitoring area 16. In this way, the monitoring area 16 can be illuminated by the respective transmission signals 20 over a large area and thus simultaneously scanned for objects 18. In this case, the LiDAR system 12 is designed as a flash LiDAR system by way of illustration. Alternatively, the LiDAR system may also be designed as a scanning LiDAR system. In this case, instead of or in addition to the transmission optics 32, there may be provision for a signal deflection device, for example a deflection mirror or the like, that can be used to swivel the direction of propagation of the transmission signals 20 in the monitoring area 16. As such, the monitoring area 16 can be progressively scanned by the transmission signals 20.

The laser control device 36 comprises the already mentioned interferometer 40, an optical control detector 42, an evaluation means 44 and a laser control means 46. The evaluation means 44 and the laser control means 46 are integrated in the control and evaluation device 38 of the LiDAR system 12 by way of illustration.

The interferometer 40 is designed as a Mach-Zehnder interferometer by way of illustration. Alternatively, a suitable other interferometer can also be used.

The interferometer 40 comprises a first optical branch 48 and a second optical branch 50.

Furthermore, the interferometer 40 comprises an input coupler 52, for example in the form of a beam splitter. The input coupler 52 is located at the beginning of the first optical branch 48 and the second optical branch 50. The input coupler 52 forms the input of the interferometer 40. The input coupler 52 can be used to split the control signals 38 that come from the branching means 34 into the first optical branch 48 and the second optical branch 50.

Additionally, the interferometer 50 comprises a decoupler 54. The decoupler 54 is located at the end of the first optical branch 48 and the second optical branch 50. The decoupler 54 can be used to merge the components of the optical control signal 38 that are guided by each of the optical branches 48 and 50, the waves being able to be superimposed. The merged components of the optical control signal 38 can be output as an interference signal 56 and transmitted to the control detector 42.

Overall, the control signal 38 can be interferometrically treated by the interferometer 50. The interferometrically treated control signal 38 forms the interference signal 56. Since the control signal 38 is the branched component of the transmission signal 20, the interference signal 56 is accordingly also the interferometrically treated transmission signal 20. The interference signal 56 can be used to characterize properties of the transmission signal 20, for example the wavelength of the transmission signal 20.

In addition, the interferometer 40 comprises an optical delay element 58 in the form of an optical microresonator by way of illustration. The optical microresonator is designed, for example, as an optical whispering gallery resonator in the form of a traveling wave ring resonator. The optical delay element 58 is located in the first optical branch 48. The optical delay element 58 can be used to delay the component of the control signal 38 that is guided by the first optical branch 48. The delay time can be used to specify the operating point of the interferometer 40.

FIG. 3 shows a ray optical model of a confinement of the control signal 38 in the delay element 58. FIG. 4 shows a wave optical model of the confinement of the control signal 38 in the delay element 58. The control signal 38 is totally reflected by the peripheral face of the delay element 58, namely the annular microresonator. This leads to constructive interference in the circulating laser wave of the control signal 38.

Moreover, the interferometer 40 has an adjusting means 60, for example in the form of a heating element, that is associated with the optical delay element 58. The adjusting means 60 is connected to the laser control means 46 in an adjustable manner. Appropriate adjustment of the adjusting means 60 allows the temperature of the optical delay element 58 to be altered. In this way, a characteristic impedance of the optical delay element 58 can be set. The characteristic impedance can be used to define times for injecting the component to be delayed of the control signal 48 and for correspondingly decoupling said component from the optical delay element 58 and thus the dwell time of the control signal 48 in the delay element 58, that is to say the delay time.

The control detector 42 is designed, for example, as a photoelectric element, for example as a photodiode or the like. The control detector 42 can be used to convert the incident interference signals 56 into electrical signals. The electrical signals can be fed to the evaluation means 44. The evaluation means 44 can be used to generate appropriate laser control variables from the electrical signals. The laser control means 46 can be used to control the laser 30 on the basis of the laser control variables. For example, the laser control variables can be taken as a basis for regulating the output wavelength of the laser 30.

The receiving device 26 has an electro-optical receiver that can be used to convert the laser echo signals 22 into electrical received signals. The electrical received signals can be transferred to the control and evaluation device 28 for further processing. The electro-optical receiver of the receiving device 26 may, for example, be designed as a point detector, in particular as a photodiode or the like, a line detector, in particular as a diode array or the like, or an area detector, in particular as a CCD array or an active pixel array or the like.

The LiDAR system 12 is designed as a photonic integrated circuit (PIC) by way of illustration. In an alternative configuration, not shown, of the LiDAR system 12, only individual parts of the LiDAR system 12 may be designed as a photonic integrated circuit.

During operation of the LiDAR system 12, the laser 30 is driven by the laser control means 46 to emit transmission signals 20. The transmission signals 20 are transmitted to the branching means 34. The branching means 34 are used to split the transmission signals 20. One portion is transmitted to the optical interferometer 40 as a control signal 38.

The other portion of the transmission signals 20 enters the monitoring area 16 through the transmission optics 32. If the transmission signals 20 hit an object 18, they are reflected as echo signals 22.

Echo signals 22 reflected toward the LiDAR system 12 are received by the receiving device 26 and converted into electrical received signals.

The electrical received signals are transferred to the control and evaluation device 28. The control and evaluation device 28 is used to obtain object information about the object 18, for example the distance, the direction and/or the speed of the object 18 relative to the LiDAR system 12, from the electrical received signals. The object information is transferred to the driver assistance system 14 and used by the latter for autonomous or semi-autonomous operation of the vehicle 10.

The control signals 38 are split by the input coupler 52 onto the first optical branch 48 and the second optical branch 50 of the interferometer 40. The respective components of the control signals 38 follow the respective optical branch 48 or 50. The applicable component of the control signals 38 in the first optical branch 48 is delayed by the delay element 58. To this end, the delay time is set using the adjusting means 60. The adjusting means 60 is adjusted using the laser control means 46.

At the end of the optical branches 48 and 50, the components of the control signals 38 are merged by the output coupler 54 to produce interference signals 56.

The interference signals 56 are transmitted to the control detector 42. The control detector 42 is used to convert the interference signals 56 into electrical signals.

The electrical signals are transferred to the evaluation means 44. The evaluation means 44 is used to compare the electrical signals with electrical nominal signals that characterize the target state of the laser 30 with respect to generation of the transmission signals 20. The nominal signals can, for example, be stored in advance in a storage means of the laser control device 36. In the target state of the laser 30, the latter generates transmission signals 20 with a specified output wavelength. If the electrical signals diverge from the electrical nominal signals, control of the laser 30 is corrected accordingly using the laser control means 46. The laser control device 36 is thus used to implement regulation of the laser 30, especially of the output wavelength of the transmission signals 20.

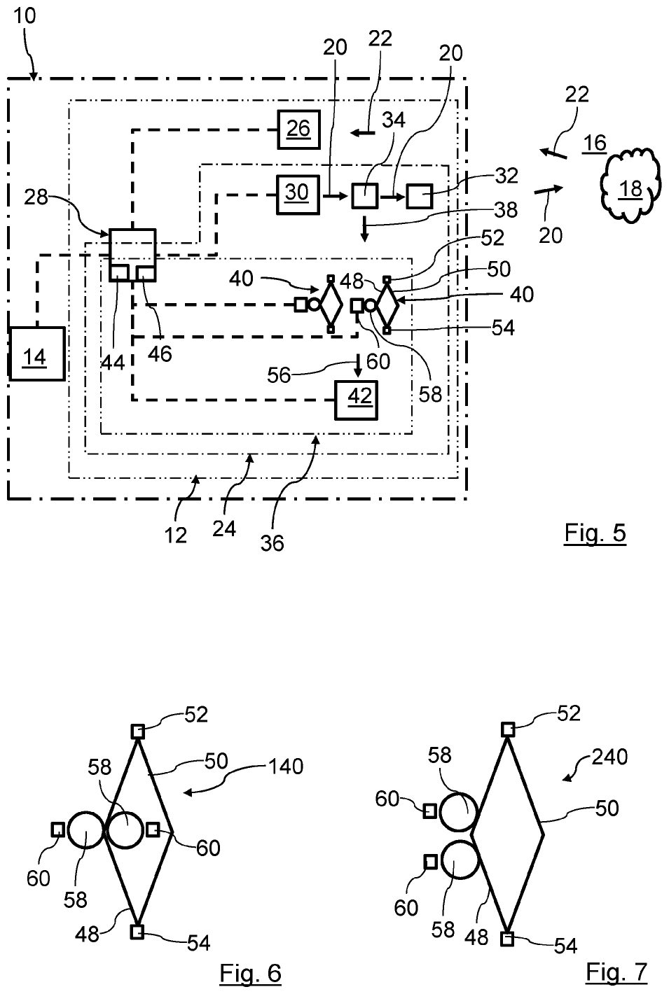

FIG. 5 shows the vehicle 10 with a LiDAR system 12 according to a second exemplary embodiment. Those elements which are similar to those of the first exemplary embodiment from FIG. 2 are provided with the same reference signs. The second exemplary embodiment differs from the first exemplary embodiment in that the laser control device 36 according to the second exemplary embodiment has two optical interferometers 40. The two optical interferometers 40 are arranged functionally in parallel in the first optical branch 48. The two interferometers 40 can be adjusted independently of each other by their respective adjusting means 60, and so they have different operating points. This allows the output wavelength of the laser 30 to be regulated even more accurately.

FIG. 6 shows an interferometer 140 for a LiDAR system 12 according to a third exemplary embodiment. Those elements which are similar to those of the first exemplary embodiment from FIG. 2 are provided with the same reference signs. The third exemplary embodiment differs from the first exemplary embodiment in that the first optical branch 48 has two optical delay elements 58 arranged functionally in parallel in it. The two optical delay elements 58 can be adjusted separately from each other by their respective adjusting means 60. This allows the delay time in the first optical branch 48 to be set more flexibly.

FIG. 7 shows an interferometer 240 for a LiDAR system 12 according to a fourth exemplary embodiment. Those elements which are similar to those of the first exemplary embodiment from FIG. 2 are provided with the same reference signs. The fourth exemplary embodiment differs from the first exemplary embodiment in that the first optical branch 48 has two optical delay elements 58 arranged functionally in series in it. The optical delay elements 58 can be adjusted separately from each other by their respective adjusting means 60. This allows the delay time in the first optical branch 48 to be set over a larger delay range overall.

1. An optical interferometer for a laser control device for at least one laser of at least one LiDAR system for a vehicle, the optical interferometer comprising:
at least two optical branches for guiding optical waves,
wherein at least one of the at least two optical branches comprises at least one optical microresonator arranged in the optical branch to delay optical waves in the corresponding at least one optical branch.

2. The optical interferometer as claimed in claim 1,
wherein at least one optical microresonator is a traveling wave resonator, an optical whispering gallery resonator or an integrated ring resonator, or
wherein the optical interferometer is implemented as part of an integrated optical system.

3. The optical interferometer as claimed in claim 1,
wherein at least one of the optical branches comprises at least two optical microresonators arranged functionally in parallel in the optical branch, or
wherein at least one of the optical branches comprises at least two optical microresonators arranged functionally in series in the optical branch.

4. The optical interferometer as claimed in claim 1,
wherein at least one optical microresonator comprises at least one associated adjusting means.

5. A laser control device for at least one laser for at least one LiDAR system for at least one vehicle, the laser control device comprising:
at least one optical interferometer for interferometrically treating laser waves generated by the at least one laser,
at least one evaluation means for determining control variables from laser waves interferometrically treated by the at least one interferometer, and
at least one control means for controlling the at least one laser on the basis of control variables determined by at least one evaluation means,
wherein the laser control device comprises at least one interferometer as claimed in claim 1.

6. The laser control device as claimed in claim 5,
wherein at least one output of at least one interferometer comprises at least one electro-optical detector arranged downstream of the output, which is connected to at least one evaluation means of the laser control device for signal transfer purposes.

7. The laser control device as claimed in claim 5,
wherein at least one evaluation means of the laser control device or at least one control means of the laser control device is implemented at least in part by means of a control and evaluation device of at least one LiDAR system.

8. A transmitting device for a LiDAR system for a vehicle, the transmitting device comprising:
at least one laser for generating laser waves; and
at least one laser control device for controlling the at least one laser,
wherein the transmitting device comprises at least one laser control device as claimed in claim 5.

9. The transmitting device as claimed in claim 8,
wherein at least one laser and at least one interferometer of the at least one laser control device comprise at least one beam splitter, arranged between the laser and the interferometer to split the laser waves generated by the at least one laser.

10. The transmitting device as claimed in claim 8,
wherein the transmitting device is implemented at least in part as integrated optics.

11. A LiDAR system for at least one vehicle, the LiDAR system comprising:
at least one transmitting device for transmitting optical waves into at least one monitoring area;
at least one receiving device for receiving optical waves from the at least one monitoring area; and
at least one control and evaluation device for controlling the at least one transmitting device and the at least one receiving device and for evaluating received variables determined by the receiving device,
wherein the LiDAR system comprises at least one transmitting device as claimed in claim 8.

12. The LiDAR system as claimed in claim 11,
wherein the at least one LiDAR system is implemented at least in part as integrated optics.

13. A vehicle comprising: at least one LiDAR system, wherein the vehicle comprises at least one LiDAR system as claimed in claim 11.

14. A method for operating an optical interferometer, for a laser control device for at least one laser of at least one LiDAR system for a vehicle,
the method comprising:
splitting optical waves into at least two optical branches; and
guiding the optical waves in the optical branches,
wherein the optical waves being are delayed in at least one of the at least two branches,
wherein the optical waves in at least one optical branch are reflected to delay the optical waves.

15. The method as claimed in claim 14,
wherein the delay time for the optical waves in the at least one optical branch is set.
